(19) United States
(12) Patent Application Publication
(10) Pub. No.: US 2013/0029717 A1
(43) Pub. Date: Jan. 31, 2013

(54) MOBILE STATION AND TRANSMISSION POWER CONTROL METHOD

(71) Applicant: Yoshimitsu SAITOH, Kawasaki (JP)

(72) Inventor: Yoshimitsu SAITOH, Kawasaki (JP)

(73) Assignee: FUJITSU LIMITED, Kawasaki-shi (JP)

(21) Appl. No.: 13/535,063

(22) Filed: Jun. 27, 2012

(30) Foreign Application Priority Data
Jul. 26, 2011 (JP) 2011-163611

(51) Int. Cl. H04W 52/24; H04W 24/00

(52) U.S. Cl. 455/522

(57) ABSTRACT

A mobile station includes a monitor configured to monitor an amount of change of timing which is indicative of transmitting data from the mobile station to a base station, and a controller configured to control a value of a transmission power required for transmitting the data when the amount reaches to a certain value.

### CROSS-REFERENCE TO RELATED APPLICATION

This application is based upon and claims the benefit of priority of the prior Japanese Patent Application No. 2011-163611, filed on Jul. 26, 2011, the entire contents of which are incorporated herein by reference.

### FIELD

The embodiment discussed herein is related to a mobile station and a transmission power control method.

### BACKGROUND

During wireless communication between a mobile station and a base station, transmission power control (TPC) is conventionally used as a technique for controlling power desired for data transmission from the mobile station to the base station. With TPC, the base station first receives data from the mobile station and detects a reception level thereof. When the reception level is equal to or less than a certain value, the base station instructs the mobile station to raise a TPC value indicative of a transmission power value at the mobile station side by communicating to the mobile station the TPC value using a downlink control channel. Conversely, when the reception level is higher than the certain value, the base station instructs the mobile station to lower the TPC value by communicating the TPC value to the mobile station. The mobile station lowers or raises the transmission power in frame units based on the TPC value to establish an appropriate value for the reception level when the TPC value is communicated by the base station (see, for example, Japanese Patent Laid-open No. 6-216788, Japanese Patent Laid-open No. 2004-208180, and Japanese Patent Laid-open No. 11-261480).

### SUMMARY

According to an aspect of the invention, a mobile station includes a monitor configured to monitor an amount of change of timing which is indicative of transmitting data from the mobile station to a base station, and a controller configured to control a value of a transmission power required for transmitting the data when the amount reaches to a certain value.

According to another aspect of the invention, a transmission power control method performed by a processor includes monitoring, by the use of the processor, an amount of change of timing which is indicative of transmitting data from the mobile station to a base station, and controlling a value of a transmission power required for transmitting the data when the amount reaches to a certain value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a positional relationship between a base station and a mobile station, and a moving direction of the mobile station;

FIG. 2 is a diagram illustrating a functional configuration of a mobile station;

FIG. 3 is a diagram illustrating hardware configuration of a mobile station;

FIG. 4 is a diagram illustrating a first part of a timing chart to explain transmission power control processing;

FIG. 5 is a diagram illustrating a second part of a timing chart to explain transmission power control processing; and

FIG. 6 is a timing chart to describe transmission timing control processing.

### DESCRIPTION OF EMBODIMENT

In respect to the above art described in the background, a time lag may occur in the transmission power control timing due to the mobile station state since the mobile station controls its own transmission power based on the instruction from the base station. In other words, when the mobile station moves from the periphery of a cell covered by the base station cell toward the base station, the base station sends an instruction to the mobile station to reduce the TPC value of the mobile station as described in the background. In this case, the instruction from the base station side may not be carried out quickly enough and a delay of a certain amount of frames may be generated in the transmission power control on the mobile station side when, for example, the mobile station is moving toward the base station side at a high speed. As a result, the mobile station transmission power becomes a value that is excessive and does not correspond to the reception level. This may increase the power consumption of the mobile station or cause the generation of interference with other mobile stations near the base station.

In consideration of the above problem, it is an object in one aspect of the invention to provide a mobile station that may control an excess of transmission power from the mobile station, and a transmission power control method.

The following is a detailed explanation of an embodiment of a mobile station and a transmission power control method disclosed in the present application with reference to the accompanying drawings. The mobile station and the transmission power control method disclosed herein are not limited to the following embodiment.

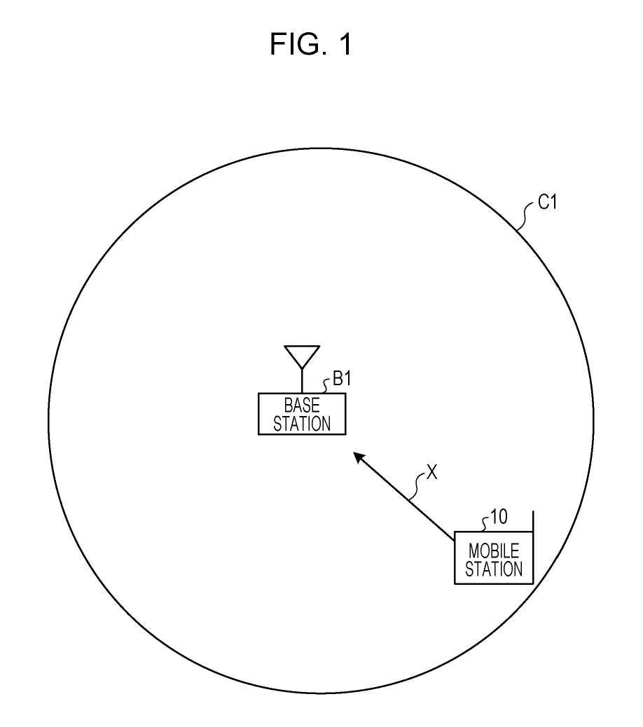

An embodiment of the mobile station and the transmission power control method disclosed herein will be explained with reference to the drawings. As a premise to the explanation, in the present embodiment it is assumed that a mobile station 10 is present at an edge of a cell C1 formed by a base station B1 as illustrated in FIG. 1. The explanation will refer to transmission power control as the mobile station 10 moves in the direction of the arrow X. Since the mobile station 10 moves from the edge of the cell C1 in a direction that approaches the base station B1, the mobile station 10 reduces the transmission power to the base station B1 accompanying such movement.

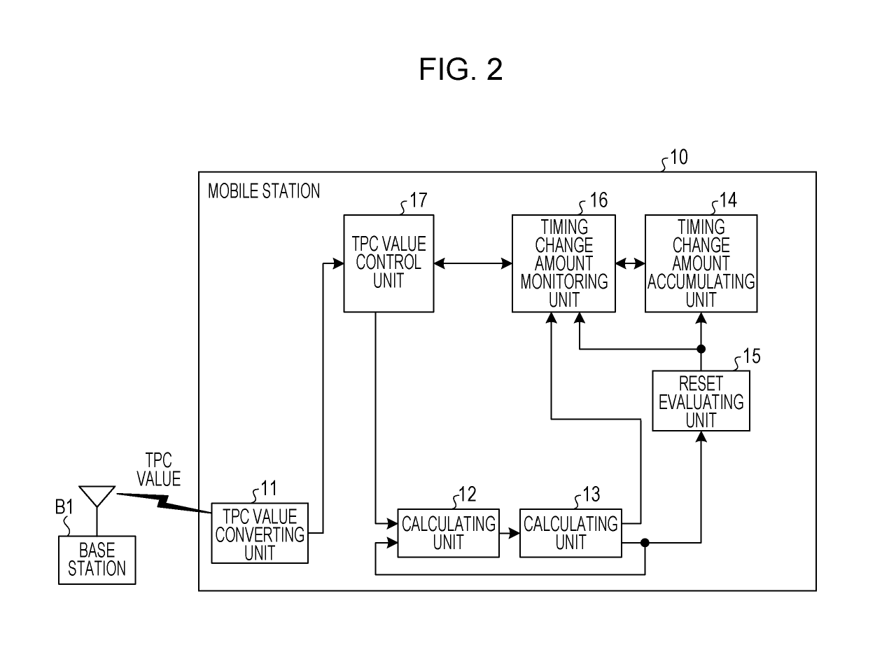

A configuration of a mobile device according to a first embodiment disclosed herein will be described first. FIG. 2 describes a functional configuration of the mobile station 10. As illustrated in FIG. 2, the mobile station 10 includes a TPC value converting unit 11, a first calculating unit 12, a second calculating unit 13, a timing change amount accumulating unit 14, a reset evaluating unit 15, a timing change amount monitoring unit 16, and a TPC value control unit 17. The components are connected to allow for one-way or two-way inputting and outputting of signals and data.

The TPC value converting unit 11 receives a TPC value as an UP or a DOWN command from the base station B1 and then converts the TPC value to a range (dB value) for increasing or decreasing the current TPC value. The TPC value converting unit 11 then outputs to the TPC value control unit 17 the dB value that is a result of the TPC value conversion.

The first calculating unit 12 receives a control signal from the TPC value control unit 17 described below and a transmission power calculation result from the second calculating unit 13 described below as input signals. The first calculating unit 12 then adds the TPC value to the calculation result or subtracts the TPC value from the calculation result according to the control signal. This calculation processing is conducted in frame units and the calculation result is outputted to the downstream second calculating unit 13.

The second calculating unit 13 receives a transmission power initial value and the calculation result from the first calculating unit 12 as input signals, and then outputs the addition result of the initial value and the calculation result as the TPC value. The TPC value is fed back to the first calculating unit 12 and outputted to the reset evaluating unit 15 and the timing change amount monitoring unit 16 which are described below.

The timing change amount accumulating unit 14 accumulates downlink path fluctuation information (hereinbelow, simply referred to as “path fluctuation information”) and timing advance information while a reset state is set to a released state by the reset evaluating unit 15. The accumulation result is outputted to the timing change amount monitoring unit 16 as transmission timing change amounts. The path fluctuation information is information that indicates transmission timing change amounts from the result of a downlink path search (downlink tracking control). The timing advance information is a transmission timing control command transmitted from the base station B1. The mobile station 10 conducts data transmission to the base station B1 based on the command after making adjustments for changes in the distance to the base station B1. The mobile station 10 conducts precise timing control based on the path fluctuation information after changing coarsely the transmission timing based on the timing advance information when implementing transmission timing control.

The reset evaluating unit 15 compares a beforehand set reset power value (for example, 18 dB) with the TPC value inputted in frame units. The reset evaluating unit 15 informs the timing change amount accumulating unit 14 and the timing change amount monitoring unit 16 that the TPC value exceeds the reset power value if the comparison indicates as such. Similarly, the reset evaluating unit 15 informs the timing change amount accumulating unit 14 and the timing change amount monitoring unit 16 that the TPC value is equal to or lower than the reset power value if the comparison indicates as such. The reset evaluating unit 15 resets the accumulation result in the timing change amount accumulating unit 14 to cause the accumulation result to be returned to the state before the reset release (the amount of transmission timing changes=0).

Upon being informed that the TPC value exceeds the reset power value by the reset evaluating unit 15, the timing change amount monitoring unit 16 starts to monitor the amount of transmission timing changes toward the base station B1 accumulated in the timing change amount accumulating unit 14. Upon subsequently being informed that the TPC value does not exceed the reset power value by the reset evaluating unit 15, the timing change amount monitoring unit 16 stops monitoring the amount of transmission timing changes. The monitoring result is outputted to the TPC value control unit 17.

The TPC value control unit 17 compares the transmission timing change amount that is the monitoring result inputted from the timing change amount monitoring unit 16 with a previously set timing threshold (for example, −14), and reduces the TPC value if the change amount reaches or exceeds the timing threshold. The TPC value control unit 17 reduces the TPC value by forcefully modifying the rise and fall of the TPC value of a previously set TPC control frequency amount (for example, 3 frames) from plus (UP) to minus (DOWN). The TPC value control unit 17 then outputs the reduced TPC value to the first calculating unit 12.

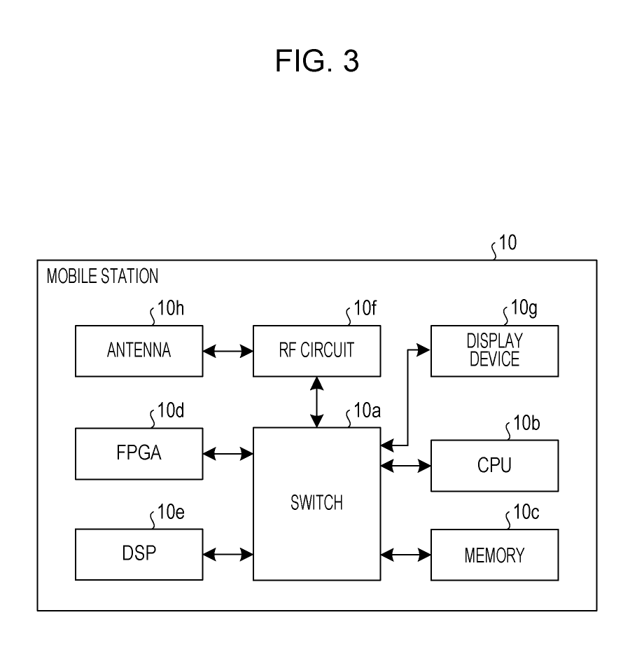

FIG. 3 illustrates a hardware configuration of the mobile station 10. As illustrated in FIG. 3, a CPU 10b, a memory 10c, a Field Programmable Gate Array (FPGA) 10d, a Digital Signal Processor (DSP) 10e, a Radio Frequency (RF) circuit 10f, and a display device 10g are interconnected in the mobile station 10 to allow for the input and output of various types of signals and data through a switch 10a. The RF circuit 10f has an antenna 10h. The TPC value converting unit 11, the first calculating unit 12, the second calculating unit 13, the reset evaluating unit 15, the timing change amount monitoring unit 16, and the TPC value control unit 17 of the mobile station 10 are realized, for example, by the CPU 10b or the DSP 10e. The timing change amount accumulating unit 14 is realized by a Random Access Memory (RAM), a Read Only Memory (ROM), a flash memory and the like of the memory 10c.

Operations of the mobile station 10 will be described next.

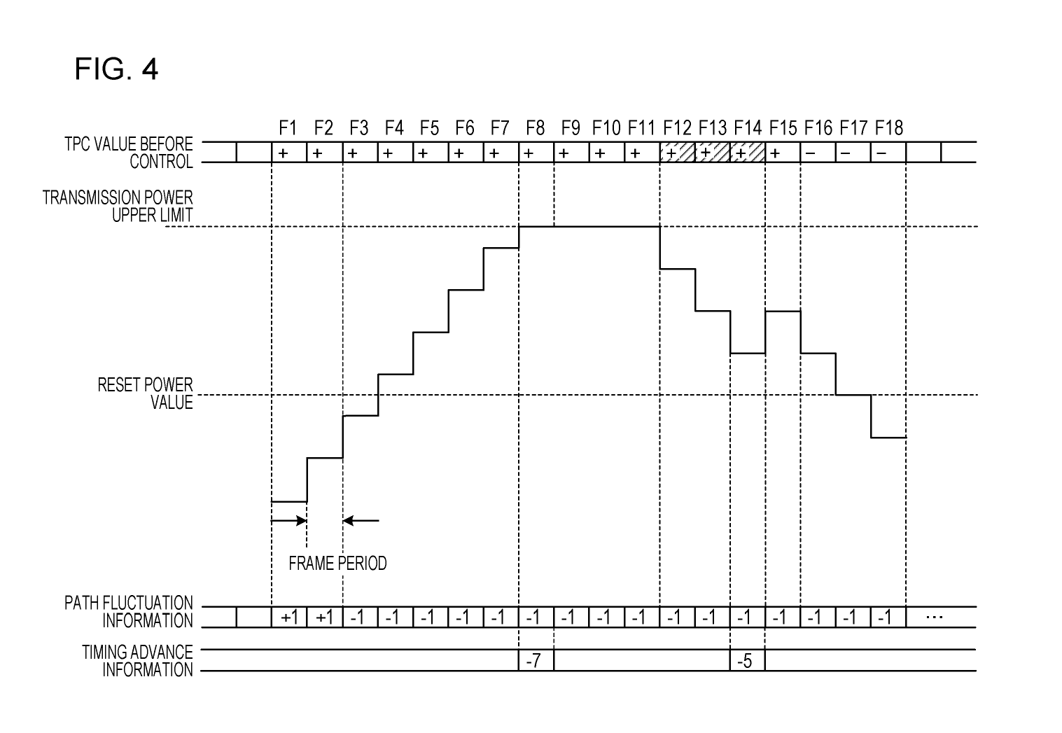

FIG. 4 describes a first part of a timing chart to explain transmission power control processing. As a premise to the description of the operations, the states of rising and falling of the TPC value before the transmission power control are described with a “+” sign for an increase in frames F1 to F15, and with a “−” sign for a decrease in frames F16 to F18 as illustrated in FIG. 4. Before the transmission power control of the mobile station 10, the TPC value rises and falls by certain values in frame units based on instructions (UP and DOWN commands) from the base station B1. The certain value may be 2 dB for example, and the frame period may be 1 ms for example. The transmission timing change amount is set at “−14” and a reduction control frequency is specified as “3” in the mobile station 10.

Time t is prescribed in the x-axis direction and the TPC value is prescribed in the y-axis direction in FIG. 4. A “transmission power upper limit” of the TPC value is set as the inherent TPC value upper limit in the mobile station 10. A “reset power value” of the TPC value is set as the TPC value when the reset state is released. The transmission power upper limit may be 23 dB for example, and the reset power value may be 18 dB for example. The TPC value of the mobile station 10 rises over time from the frame F1, exceeds the reset power value at the frame F4, and reaches the transmission power upper limit at the frame F8. The TPC value is then reduced for three frames by the TPC value control unit 17 in contradiction to the UP command from the base station B1. When the reduction by the mobile station 10 is finished, the TPC value rises once again according to the instruction from the base station B1, and then falls to a value below the reset power value.

As described above, although the TPC value rises and falls as the frames advance accompanying the passage of time, the path fluctuation information, except for the frames F1 and F2, takes on a minus value since the distance from the mobile station 10 to the base station B1 is shortened. Similarly, the timing advance information from the frames F8 and F14 takes on the respective minus values of −7 and −5 due to the approach of the mobile station 10 toward the base station B1.

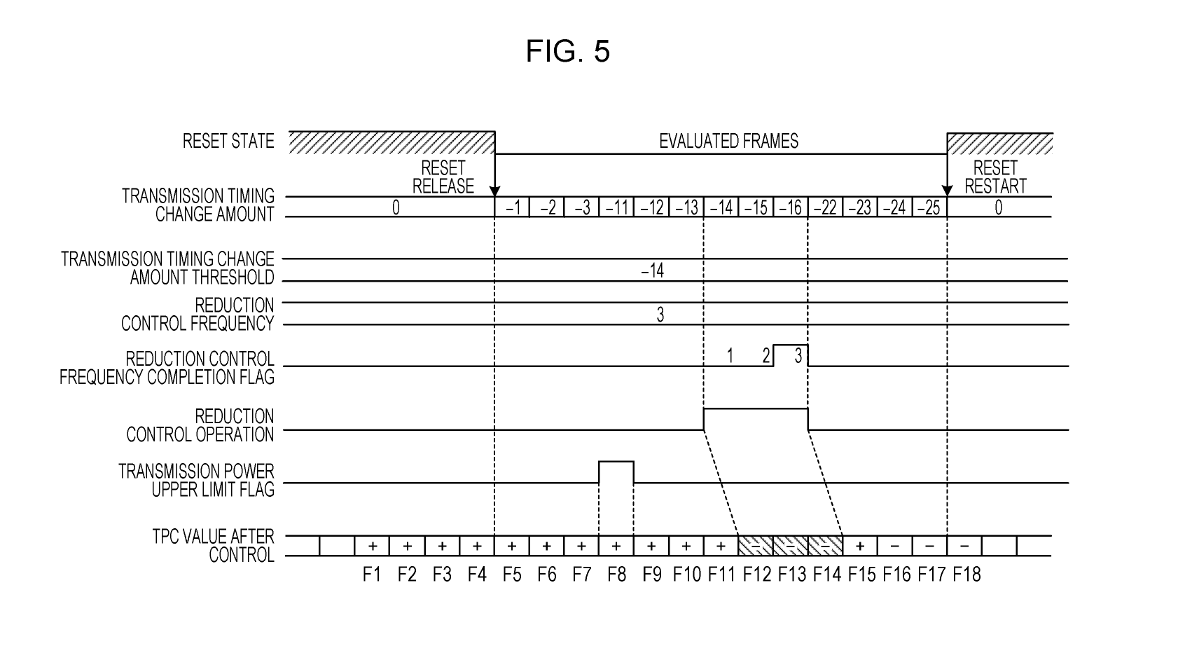

As illustrated in FIG. 5, the transmission timing change amounts are not accumulated in the timing change amount accumulating unit 14 in the frames F1 to F4 since the mobile station 10 is under the reset state in those frames. When the TPC value exceeds the reset power value in the frame F4, the mobile station 10 starts to accumulate the transmission timing change amounts from the next frame F5 and the subsequent frames. In the frame F18, the TPC value then falls below the reset power value again and the reset state is restarted. Specifically, although the transmission timing change amount is zero while the mobile station 10 is under the reset state, calculation and accumulation are started upon the release of the reset state. The accumulated transmission timing change amount is reset to zero accompanying the restart of the reset. Therefore, according to the present embodiment, the frames (evaluated frames) referenced to evaluate whether or not transmission power control is desired are the frames F5 to F17.

As described in FIG. 4 according to the present embodiment, the path fluctuation information indicates the value “−1” for all the frames from the frame F5 to the frame F17. The timing advance information indicates the value “−7” in the frame F8 and the value “−5” in the frame F14. The amount of change of the transmission timing is an accumulated value of the sum of the path fluctuation information and the timing advance information for each of the frames. Thus, the change amount in the frame F5 becomes “−1”, and the change amount in the frame F8, for example, becomes “−11” (=−1×4−7). Since the timing advance information value is “−5” at the frame F14, the transmission timing change amount at the same frame is calculated as “−22” based on the sum of the path fluctuation information change amount which is −10 (=−1×10) and the timing advance information change amount which is −12 (=−7−5).

As described above, since the transmission timing change amount threshold is set at “−14” in the present embodiment, the change amount of the transmission timing reaches the threshold at the frame F11. Since the reduction control frequency is set to “3”, a reduction control frequency completion flag is set at the frame F13 which is the third frame after the starting frame F11. As a result, the TPC value control unit 17 of the mobile station 10 maintains the transmission power reduction control in an operative state in the frames F11 to F13. The transmission power reduction control enters an inoperative state again from the frame F14 which is the frame after the reduction control frequency completion flag.

Since the TPC value reaches the upper limit at the frame F8 (see FIG. 4) and the frame F8 is one of the evaluated frames described above, the TPC value control unit 17 sets a transmission power upper limit flag at the frame F8.

The mobile station 10 implements controls to cause the TPC value control unit 17 to reduce the TPC value based on the frames F11 to F13 in which the reduction control is in the operative state. Thus, the TPC values in the frames F12 to F14 are reduced accompanying a time lag of one frame. As a result, when the mobile station is in a reset release state, the mobile station 10 spontaneously reduces the transmission power regardless of any increase or decrease instructions from the base station B1 when the transmission power upper limit flag is set and the transmission timing change amount has reached the threshold.

By limiting the frames to be evaluated to the frames under the reset release state, the mobile station 10 may limit the implementation of the transmission timing change amount calculation and accumulation processing to a time when the TPC value is high and thus reduce undesired processing. By limiting the time of the implementation of the transmission power reduction control to a time when the transmission power upper limit flag is set, the mobile station 10 may forestall the implementation of the reduction control until a time in which the transmission power is not so high as to be reduced. Furthermore, the mobile station 10 limits the time when transmission power reduction control is being implemented to a time when the change amount of the transmission timing has reached the threshold. As a result, the mobile station 10 limits the implementation of the transmission power reduction control to a time when the mobile station 10 is approaching the base station B1 and thus avoids the reduction of the transmission power at a time when the transmission power is not excessive such as times when the mobile station 10 is stopped or when the mobile station 10 is moving farther away from the base station B1. As a result, a situation is avoided in which the mobile station 10 reduces the transmission power to cause the transmission power to become inadequate thus hampering the transmission of data to the base station B1.

Next, a method will be described in which the TPC value control unit 17 of the mobile station 10 controls the transmission timing using the path fluctuation information and the timing advance information. The base station B1 measures the transmission timing of the mobile station 10 from data that is received from the mobile station 10. The base station B1 calculates a timing fluctuation amount to match the timing in which signals from the mobile station 10 reach the base station B1 with timings of other mobile stations connected to the base station B1. The base station B1 inserts the result of the calculation as the timing advance information into data to be subsequently transmitted to the mobile station 10.

Upon receiving the data from the base station B1, the mobile station 10 detects the beginning position of the data. If the currently detected beginning position fluctuates from a previously detected data beginning position or from a predetermined receiving time, the mobile station 10 stores the amount of fluctuation in the memory 10c as the path fluctuation information. The mobile station 10 extracts the above-mentioned timing advance information inserted at the base station B1 side from the received data. The mobile station 10 uses the information (the path fluctuation information and the timing advance information) to fluctuate the transmission timing of data to the base station B1. For example, if the mobile station 10 detects a value of “+1” as the path fluctuation information, the TPC value control unit 17 moves the beginning position of the transmitting data “1” clock amount to the plus side (direction to delay the transmission timing). Conversely, if the mobile station 10 detects a value of “−5” as the timing advance information, the TPC value control unit 17 moves the beginning position of the transmitting data “5” clock amounts to the minus side (direction to advance the transmission timing).

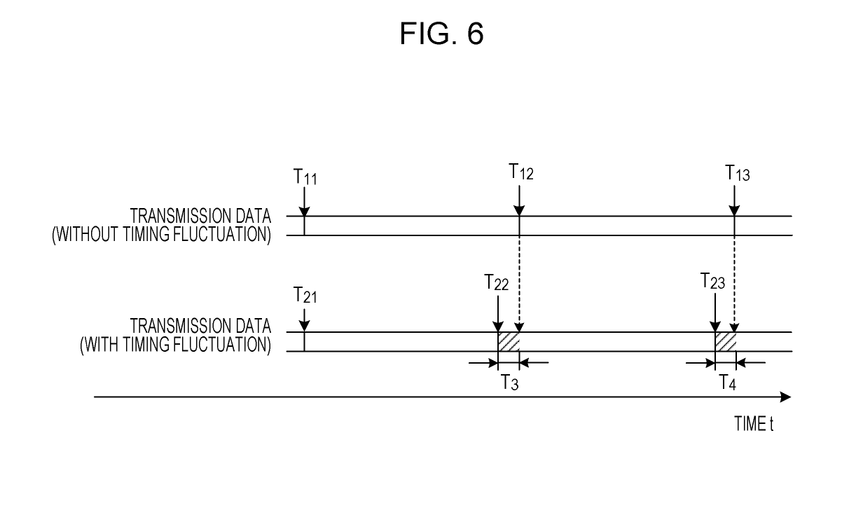

FIG. 6 is a timing chart to describe transmission timing control processing. Time t is prescribed in the x-axis in FIG. 6. Transmission data beginning positions T₁₁, T₁₂, and T₁₃ are spaced at equidistant intervals in FIG. 6 when fluctuations in timing are not produced (the mobile station 10 is stopped). Meanwhile, among data transmission beginning positions T₂₁, T₂₂, and T₂₃ that indicate when timing fluctuations occur (when the mobile station 10 is approaching the base station B1), the data beginning positions T₂₂ and T₂₃ are compared to the previous data beginning positions T₁₂ and T₁₃. As a result, fluctuations to earlier times may be seen with respective time periods T₃ and T₄. The TPC value control unit 17 of the mobile station 10 detects the beginning positions of transmission data at periods of, for example, several tens of milliseconds, and recognizes detected shifts in the beginning positions (corresponding to the above time periods T₃ and T₄) as the abovementioned path fluctuation information.

As described above, the mobile station 10 according to the present embodiment includes the timing change amount monitoring unit 16 and the TPC value control unit 17. The timing change amount monitoring unit 16 monitors the change amounts of timing for transmitting data to the base station B1. The TPC value control unit 17 reduces the transmission power value to transmit data to the base station B1, when the change amount reaches a certain value (transmission timing change amount threshold) according to the result of the monitoring. Therefore, the mobile station 10 is able to spontaneously implement transmission power control from the mobile station without the base station taking the initiative to implement transmission power control. Thus, the mobile station 10 may easily and quickly follow desired TPC value fluctuations accompanying changes in the distance between the mobile station 10 and the base station B1. As a result, an excessive supply of transmission power that is a concern when the mobile station 10 approaches the base station B1 may be controlled and interference to and from other mobile stations connected to the same base station may be reduced.

Specifically, the mobile station 10 uses the transmission timing change amount as an indicator to determine whether or not the mobile station 10 is approaching the base station B1. When the mobile station 10 is approaching the base station B1, the transmission timing from the mobile station 10 to the base station B1 becomes quicker and the change amount takes on a minus value. Conversely, when the mobile station 10 is moving away from the base station B1, the transmission timing from the mobile station 10 to the base station B1 becomes slower and the change amount moves to the plus side. The transmission timing change amount may be easily derived from information that indicates a displacement of the transmitting data beginning position from a reference position (i.e., the path fluctuation information), and from information that the base station B1 uses to indicate data transmission timing to the mobile station 10 (i.e., timing advance information). Therefore, by referring to the accumulation result of the path fluctuation information and the timing advance information, the mobile station 10 is able to detect both whether or not the mobile station 10 is near the base station B1 and to what extent the mobile station 10 is approaching the base station B1 (level of approach). An excess of transmission power becomes noticeable if the distance between the mobile station 10 and the base station B1 is quickly shortened and the supply of power exceeds the desired power. As a result, the mobile station 10 is able to control excessive transmission power accompanying the movement of the mobile station 10 by reducing the transmission power based on the result of the above sensing.

By use of the existing path fluctuation information or timing advance information as the transmission timing change amounts, the mobile station 10 may also maintain the transmission power at an appropriate value without creating, modifying, or processing new information. Therefore, when implementing transmission power control, processing loads and transmission delays accompanying the transmission power control may be greatly reduced in comparison to creating and modifying new information.

In particular, the timing change amount monitoring unit 16 of the mobile station 10 monitors the timing change amounts while the transmission power value exceeds a certain value (reset power value). The mobile station 10 begins to monitor the change amounts of the transmission timing when the TPC value (transmission power value) of the mobile station 10 rises above the reset power value and stops monitoring the same when the TPC value falls below the reset power value. Specifically, while the TPC value of the mobile station 10 exceeds the reset power value, the mobile station 10 determines that the transmission power value is high regardless of whether or not the mobile station 10 is near the base station B1 and monitors the transmission timing change amount. In other words, the mobile station 10 does not have to monitor the transmission timing change amounts except for occasions where there is a fear that the transmission power may become excessive, and thus the change amounts are not accumulated except for such occasions. As a result, by avoiding the accumulation and monitoring of unnecessary data, the mobile station 10 is able to control the transmission power on the basis of a small amount of data in comparison to constantly accumulating and monitoring the transmission timing change amounts. Therefore, the mobile station 10 may reduce processing loads accompanying the monitoring processing and the amount of memory used for the accumulation processing. As a result, the speed of the transmission power control may be increased.

The timing change amount monitoring unit 16 of the mobile station 10 also monitors the accumulation result of the change amounts as opposed to only the change amounts and the TPC value control unit 17 controls the TPC value based on the accumulation result of the change amounts. As a result, the mobile station 10 may use the change amounts over a relatively long period of time as an indicator to determine whether or not the transmission power of the mobile station 10 is in a state to be reduced. Therefore, the mobile station 10 may accurately determine whether or not the transmission power is excessive by excluding the effects of transient increases and decreases and sudden fluctuations in the path fluctuation information and the timing advance information. As a result, reliability of the transmission power control implemented by the mobile station 10 may be improved.

Additionally, the TPC value control unit 17 of the mobile station 10 stops the reduction control and restarts the adjustment of the TPC value based on instructions from the base station B1 when the reduction control frequency is completed after starting the TPC value reduction control. Thus, the TPC value is not reduced to a value that hampers communication between the mobile station 10 and the base station B1 since the transmission power control initiated by the mobile station 10 is implemented temporarily. Therefore, even if the mobile station 10 approaches the base station B1, the transmission power is not reduced more than a desired amount and failures caused by a lack of transmission power may be avoided when communicating with the base station B1. As a result, the suppression of too much transmission power and the resolution of too little transmission power are both achieved.

In the above embodiment, the reset release state, the transmission power reaching the upper limit, and the transmission timing change amount reaching a threshold are established as conditions for the mobile station 10 to implement the transmission power control. However, not all of the conditions may be met. That is, the mobile station 10 may implement the transmission power control when at least one of the conditions is met. Even though a plurality of conditions is established, the order in which the conditions are met is not necessarily the same as described in the above embodiment. For example, the transmission power control may be implemented as a result of the transmission power reaching the upper limit after the transmission timing change amount has reached the threshold.

In the above embodiments, the transmission timing change amount threshold is described as “−14” and the reduction control frequency is described as “3” in order to initiate the reduction of the transmission power. However, the values may be appropriately modified according to the number of adjustments of the TPC value per one frame or according to the frequency of transmission timing changes. For example, if the transmission timing change amount threshold is set as a value lower than “−14” (e.g., −20), the TPC value may be estimated to be excessive based on the transmission timing change amount not being able to reach the threshold so long as the transmission timing change amount is not too large. Therefore, the mobile station 10 may increase the range of the lowering of the TPC value to allow for the reduction of the TPC value as early as possible by setting the reduction control frequency to a value larger than “3” (e.g., 5). As a result, wasteful use of the transmission power and interference with other mobile stations may be avoided.

Conversely, when the transmission timing change amount threshold is set to a value larger than “−14” (e.g., −10), there is a greater possibility that the transmission timing change amount may reach the threshold when the amount is not very large. If this happens, the excess of the TPC value is estimated to be small. Therefore, the mobile station 10 may decrease the range of the lowering of the TPC value to allow for adjustment of the TPC value by setting the reduction control frequency to a value smaller than “3” (e.g., 2). As a result, control of the excessive transmission power may be implemented at an earlier stage and very precise transmission power control may be implemented.

The description in the above embodiment envisages a portable telephone, a smartphone, or a Personal Digital Assistant (PDA) as the mobile station. However, the mobile station is not limited as such and the present disclosure may be applicable to various communication devices that implement transmission timing control.

The constituent elements of the mobile station 10 illustrated in FIG. 2 may not be configured physically as illustrated. In other words, the embodiments are not limited to the particular forms of distribution and integration of each part and all or some of the parts may be configured to be functionally or physically distributed or integrated in arbitrary units according to the type of load or usage conditions and the like. For example, the timing change amount monitoring unit 16 and the TPC value control unit 17 may be integrated into one constituent element. Conversely, the TPC value control unit 17 may be separated into a portion that actually switches the transmission power and a portion that counts the frequency of the transmission power control. Moreover, the memory 10c may be an external device connected through a cable or a network to the mobile station 10.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A mobile station comprising:
a monitor configured to monitor an amount of change of timing, the timing being indicative of transmitting data from the mobile station to a base station; and
a controller configured to control a value of a transmission power required for transmitting the data when the amount reaches to a certain value.

2. The mobile station according to claim 1, wherein the monitor monitors the amount during which the value of the transmission power exceeds the certain value.

3. A transmission power control method performed by a processor comprising:
monitoring, by the use of the processor, an amount of change of timing, the timing being indicative of transmitting data from the mobile station to a base station; and
controlling a value of a transmission power required for transmitting the data when the amount reaches to a certain value.

4. A transmission power control method comprising:
monitoring, by a monitor, an amount of change of timing, the timing being indicative of transmitting data from the mobile station to a base station; and
controlling, by a controller, a value of a transmission power required for transmitting the data when the amount reaches to a certain value.
